(19) United States
(12) Patent Application Publication
(10) Pub. No.: US 2015/0097804 A1
(43) Pub. Date: Apr. 9, 2015

(54) Method for manipulating the touchscreen of a mobile computer

(71) Applicants: Evgenli Sergeevich GORYAINOV, Kungur (RU); Andrei Aleksandrovich ELISEEV, Perm (RU); Ruslan Anatolievich KORESHKOV, Perm (RU)

(72) Inventor: Ruslan Anatolievich Koreshkov, Perm (RU)

(21) Appl. No.: 14/385,293

(22) PCT Filed: Mar. 20, 2013
(86) PCT No.: PCT/RU13/00232

§ 371 Date: Sep. 15, 2014

(30) Foreign Application Priority Data
Mar. 22, 2012 (RU) 2012111019

(51) Int. Cl. G06F 3/044; G06F 3/02; G06F 3/041

(52) U.S. Cl. CPC G06F 3/044; G06F 3/0412; G06F 3/0227
USPC 345/174

(57) ABSTRACT

A device for manipulating a mobile computer is proposed. The device includes a case, a number of buttons mounted thereon having switchable contacts, electrical contact elements attached to the computer's touch screen, a metal capacitive plate attached to the case while electrically connected with the switchable contacts, and electric circuits each connected to one corresponding contact element and to the switchable contacts. The switchable contacts are normally disconnected, while, when the respective button is pressed upon by a user, they are connected thereby connecting the contact elements with the metal plate. Preferable parameters and materials of the device's components are also disclosed. Thus, the device allows for manipulating the touch screen without producing mechanical stress thereon. At the same time, the reliability of detection of control signals inputted into the computer is increased.

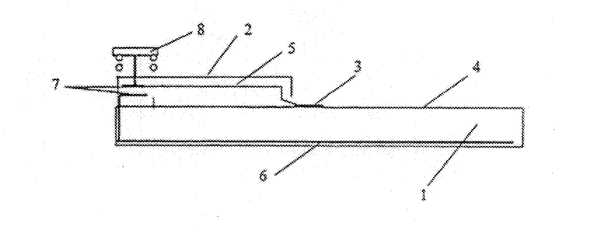

### CROSS-REFERENCE TO RELATED APPLICATIONS

This application is a U.S. national stage application of an international application PCT/RU2013/000232 filed on 20 Mar. 2013, published as WO/2013/141762, which international application claims priority of a Russian Federation patent application RU2012111019 filed on 22 Mar. 2012.

### FIELD OF THE INVENTION

The present invention relates to a device and method for manual control of a touch screen of a capacitive or projection-capacitive type and can be used in the electrical technology or electronic electro-technical industry and in the instrumentation technology.

### BACKGROUND OF THE INVENTION

There is known a method for manipulating a touchscreen of a mobile computer with the use of mechanical devices (see Patent RU No22280923 published on 27 Jul. 2005). The above method is considered to be the closest related art to the present invention.

A disadvantage of the aforementioned method is the possibility of damage of the touch screen as a result of mechanical stress, and unreliability of detection of control signals.

### BRIEF SUMMARY OF THE INVENTION

The object of the proposed method and device is to increase the service life-span of the computer screen, to enhance the reliability of detection of control signals, and to facilitate the use of the screen.

For this purpose, the inventive device and method for manipulating the computer screen of a mobile computer are proposed. The inventive method comprises: switching of electrically conductive contact elements having an electrical capacitance, which contact elements are attached to the screen.

A distinctive feature of the proposed method is the fact that the switching of the electrically conductive contact elements having an electrical capacitance and attached to the screen is carried out.

### BRIEF DESCRIPTION OF DRAWING OF THE INVENTION

The essence of the inventive device for implementation of the proposed method is explained in the FIGURE of drawing attached to the present description. The FIGURE depicts a schematic view of the inventive device.

### DETAIL DESCRIPTION OF A PREFERRED EMBODIMENT OF THE INVENTION

While the invention may be susceptible to embodiment in different forms, there will be described in detail herein, a specific embodiment of the instant invention, with the understanding that the present disclosure is to be considered an exemplification of the principles of the invention, and is not intended to limit the invention to that as illustrated and described herein.

FIGURE shows a mobile computer 1 associated with a case 2; a button 8 mounted in the case 2, and having a pair of switchable contacts 7 (e.g. the contacts 7 are normally disconnected, i.e. being in an OFF position, while, when the button 8 is pressed upon by a user, the contacts 7 are connected in an ON position), wherein the pair of switchable contacts 7 consists of a first contact 7 and a second contact 7; a screen 4; an electrically conductive contact element 3 attached to the screen 4 (generally, the inventive device may have a predetermined number of contact elements 3); a metal plate 6 attached to the case 2 and electrically connected with the second contact 7; and an electric circuit 5 connected to the contact element 3 and to the first contact 7.

Therefore, each aforesaid contact element 3 is able to connect by means of the electrically conductive circuit 5 with the capacitive metal plate 6 via the contact elements 7 of the button 8.

Capacitance of the plate 6 is preferably not less than 0.035 pF. The plate 6 may be made in the form of a metal grid located on an outer surface of the case 2 ensuring the possibility of contact with the hands of the user.

In accordance with the proposed method, the inventive device operates as follows.

By pressing the button 8 with the user's hand, the contact elements 7 of the button 8 are closed in the ON position. At the same time, the contact elements 3 is connected to the metal plate 6.

This changes electric potential of the contact element 3 as well as changes the capacitance between the contact element 3 and the screen 4.

Thus, the proposed method allows for manipulating the touch screen without producing mechanical stress thereon. At the same time, the reliability of detection of control signals inputted into the computer is increased.

### EXAMPLE OF IMPLEMENTATION OF THE INVENTION

In a prototype model for implementation of the inventive method, a device manufactured by the “LG Electronics”® company of the LG-P 970® model, equipped with a projective-capacitive screen, was associated with the aforementioned components of the inventive device.

Technical details of the prototype model follow: the size of the contact elements 3 was 10×7 mm, the material of the contact elements 3 was stainless steel. The electrically conductive plate 6 with a size of 123×63 mm was made of aluminum. Its capacitance was 0.064 pF.

Control of a game application “Muffin-Knight” was carried out with the use of the prototype model.

1. A device for manipulating a mobile computer including a display screen; said device comprising:
a case having a surface;
a predetermined number of buttons mounted on the case, each button of said predetermined number of buttons has a pair of switchable contacts normally disconnected, while, when the button is pressed upon by a user, the switchable contacts are connected, wherein each said pair of switchable contacts consists of a first contact and a second contact;
a predetermined number of electrically conductive contact elements attached to the screen:
a metal plate attached to the surface of said case and electrically connected with the second contacts of each button of said predetermined number of buttons, said metal plate has a predetermined capacitance; and
a predetermined number of electric circuits each connected to one corresponding contact element from said predetermined number of contact elements and to the first contact of a corresponding button of said predetermined number of buttons.

2. The device according to claim 1, wherein said predetermined capacitance is at least 0.035 pF.

3. The device according to claim 1, wherein said metal plate is made in the form of a metal grid.
